(19) United States
(12) Patent Application Publication
(10) Pub. No.: US 2014/0006508 A1
(43) Pub. Date: Jan. 2, 2014

(54) METHOD AND SYSTEM FOR REAL TIME SUBSCRIBER PROFILING

(71) Applicants: Jean-Philippe Goyet, Montreal (CA); Olivier Mirandette, Montreal (CA)

(72) Inventors: Jean-Philippe Goyet, Montreal (CA); Olivier Mirandette, Montreal (CA)

(21) Appl. No.: 13/826,660

(22) Filed: Mar. 14, 2013

Related U.S. Application Data
(60) Provisional application No. 61/664,798, filed on Jun. 27, 2012.

(51) Int. Cl. H04L 29/08

(52) U.S. Cl. CPC H04L 67/22
USPC 709/204

(57) ABSTRACT

A subscribers' profiling system for real-time subscriber profiling includes memorizing at least one profile consisting of a criterion and subscribers' demographic data. The subscribers' demographic data is analyzed to determine a subscriber-owned device for which the demographic criteria of a specific profile are met (by the demographic data of the subscriber). Information corresponding to the IP data traffic generated by a device is extracted in real time from the IP data records; the extracted information is analyzed in real time to determine that a contextual criterion or a data usage criterion of a specific profile is met. A computer-implemented subscriber's state manager is updated in real time when all the criteria of a specific profile are met for a device. A computer implemented subscribers' state manager memorizes a unique identifier of a device and a corresponding state of a specific profile; the corresponding state of the specific profile is indicative that all the criteria of the specific profile are met for the device.

### TECHNICAL FIELD

The present relates to the field of profiling of subscribers of an IP based communication service; and more particularly to determining in real time devices, owned by subscribers, matching a specific profile.

### SUMMARY

The present disclosure relates to a system for real time subscriber profiling. The system comprises a computer implemented real time profiler. The computer implemented real time profiler memorizes at least one profile consisting of at least one criterion. The at least one criterion consists of one of: a demographic criterion, a contextual criterion, and a data usage criterion. The computer implemented real time profiler memorizes subscribers' demographic data. The computer implemented real time profiler analyzes the subscribers' demographic data, to determine at least one device for which the demographic criteria of a specific profile are met. The at least one device is owned by a subscriber, and the demographic criteria of the specific profile are met by the demographic data of the subscriber. The computer implemented real time profiler receives, from at least one collecting entity, IP data records representative of an IP data traffic on an IP data network. The computer implemented real time profiler extracts in real time information from the IP data records. The information corresponds to the IP data traffic generated by a device. The computer implemented real time profiler analyzes in real time the extracted information, to determine that at least one of a contextual criterion or a data usage criterion of a specific profile is met. And the computer implemented real time profiler updates in real time a computer implemented subscriber's state manager, when all the criteria of a specific profile are met for a device. The system further comprises a computer implemented subscribers' state manager. The computer implemented subscribers' state manager memorizes a unique identifier of a device, and a corresponding state of a specific profile. The corresponding state of the specific profile is indicative that all the criteria of the specific profile are met for the device.

### BRIEF DESCRIPTION OF THE DRAWINGS

In the appended drawings:

FIG. 1 illustrates a system for real time subscriber profiling, according to a non-restrictive illustrative embodiment; and

FIG. 2 illustrates several types of criteria of a profile, according to a non-restrictive illustrative embodiment.

### DETAILED DESCRIPTION

The present relates to the field of profiling of subscribers of a communication service; and more particularly to determining in real time devices, owned by subscribers, matching a specific profile.

A profile is defined by criteria, each criterion of the profile being of a specific pre-defined type. A subscriber's profiling system memorizes a profile, and analyzes in real time data received from different sources. The data received from a specific source correspond to one (or several) specific pre-defined type of criterion. The real time analysis consists in determining in real time whether some of the criteria are met for data corresponding to a specific device. The matching of all the criteria of the profile for a specific device is determined in real time, and a corresponding state is updated for the specific device. The subscriber's profiling system memorizes for a device matching all the criteria of the profile: a unique identifier of the device, and the corresponding state indicative of the matching of all the criteria.

The subscriber's profiling system is adapted for managing several profiles in parallel. For this purpose, each profile may be identified by a unique profile identifier. The real time analysis is performed for each specific profile independently. Further, for a given device, the subscriber's profiling system memorizes a matching state for each specific profile, indicative of the matching of all the criteria of the specific profile by the given device.

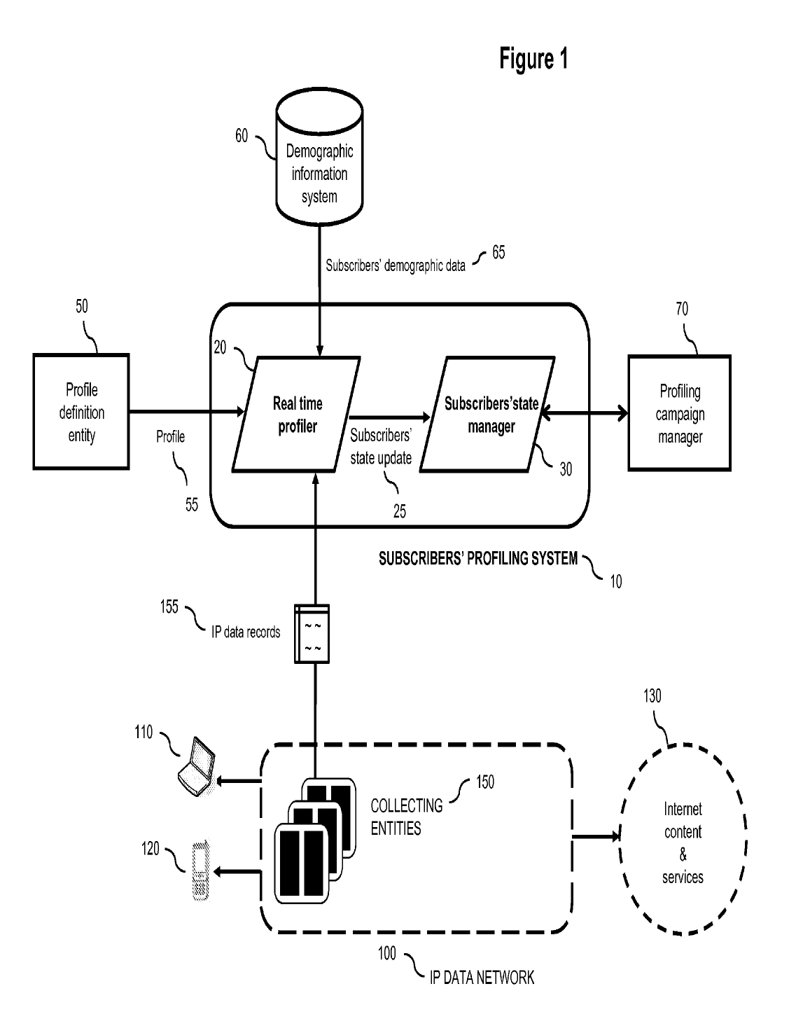

Now referring to FIG. 1, a system for real time subscriber profiling will be described.

A subscribers' profiling system 10 is represented in FIG. 1. The subscribers' profiling system 10 comprises a computer implemented real time profiler 20 and a computer implemented subscribers' state manager 30.

An embodiment of the computer implemented real time profiler 20 may comprise a generic purpose or specialized computer, and dedicated software. The dedicated software is executed on the computer, to implement the functionalities (to be further detailed in the following paragraphs) of the computer implemented real time profiler 20. For simplification purposes, the computer implemented real time profiler 20 will be referred to as the real time profiler 20 in the rest of the description. The computer includes memory, to memorize information related to the aforementioned functionalities of the real time profiler 20.

An embodiment of the computer implemented subscribers' state manager 30 may comprise a generic purpose or specialized computer, and dedicated software. The dedicated software is executed on the computer, to implement the functionalities (to be further detailed in the following paragraphs) of the computer implemented subscribers' state manager 30. For simplification purposes, the computer implemented subscribers' state manager 30 will be referred to as the subscribers' state manager 30 in the rest of the description. The computer includes memory, to memorize information related to the aforementioned functionalities of the subscribers' state manager 30.

The real time profiler 20 memorizes at least one profile. A profile consists of one or more criterion. Each criterion may be of one of the following types: a demographic criterion, a contextual criterion, and a data usage criterion. Additional types of criteria may be defined. The different types of criteria are related to subscribers of a communication service; and to devices owned by the subscribers, and used to access the IP based data services provided by the communication service.

The demographic criteria are related to demographic data representative of a subscriber. These demographic data are static, or at least do not evolve in real time. Examples of such demographic data include: the gender of a subscriber, the age of a subscriber (or a range of ages), the address of a subscriber (e.g. the full address, or a combination of at least one of a province, a city, a neighbourhood), the profession of a subscriber (or a group of similar professions), the revenue of a subscriber (or a range of revenue).

The contextual and data usage criteria are related to characteristics and behaviors of a device owned by a subscriber; and some of these characteristics and behaviors may evolve in real time.

The contextual criteria are related to characteristics and behaviors of the device itself. Example of such characteristics and behaviors include: the manufacturer of a device, the model of a device (e.g. model X in the portfolio of devices of manufacturer Y), a characteristic of a device (e.g. operating system, maximum reception or transmission bandwidth), the localisation of a device (e.g. the cell to which the device is attached in a cellular network). The localisation of a device may evolve in (almost) real time.

The data usage criteria are related to characteristics and behaviors of the consumption of IP based data services by the device. Example of such characteristics and behaviors include: an application used on a device (the usage of the application generates IP data traffic representative of the application), an Internet service consumed by a device (e.g. web browsing, video streaming, Voice over IP), a content delivered to a device (e.g. a specific web site or web page, a specific video).

A profile 55 is transmitted to the real time profiler 20, by a profile definition entity 50; and further memorized in the real time profiler 20. The profile definition entity 50 is responsible for defining the criteria of a profile. For example, a user may generate a specific profile, by selecting a list of criteria among a pre-defined list of available criteria; via a user interface provided by the profile definition entity 50. The profile definition entity 50 may also allocate a unique profile identifier to each generated profile. The unique profile identifier is transmitted to the real time profiler 20 with the generated profile. The profile definition entity 50 may generate and send several profiles 55 to the real time profiler 20, over a period of time. Also, several profile definition entities 50 may be used in parallel, to generate and send profiles 55 to the real time profiler 20, over a period of time. The profile definition entity 50 may also send a request (not represented in FIG. 1) to the real time profiler 20, to deactivate a specific profile. In this case, the deactivated profile is no longer taken into consideration in the processing performed by the real time profiler 20. Several profiles may be memorized (along with their unique profile identifiers), and processed in parallel, by the real time profiler 20. The unique profile identifier is used to identify a specific profile when the subscribers' profiling system 10 communicates with external entities, like the profile definition entity 50 and a profiling campaign manger 70 (the latter will be further detailed later in the description).

The real time profiler 20 memorizes subscribers' demographic data. As already explained, the demographic data are representative of the subscribers of the communication service.

The real time profiler 20 analyzes the subscribers' demographic data, to determine one or several devices for which the demographic criteria of a specific profile are met. Since a device is owned by a subscriber, if the demographic criteria of the specific profile are met by the demographic data of a given subscriber, then the demographic criteria of the specific profile are considered to be met for the device owned by the given subscriber.

A device is identified by a unique device identifier, and a subscriber is identified by a unique subscriber identifier. In some cases, the same unique identifier is used for the device and the corresponding subscriber. In this case, there is a direct mapping between a device and the subscriber who owns the device. In other cases, two different unique identifiers are used for the device and the corresponding subscriber. In this case, the real time profiler 20 performs a mapping between the unique device identifiers and the unique subscriber identifiers. Thus, when the demographic data of a subscriber identified by its unique subscriber identifier match the demographic criteria of a specific profile, the corresponding unique device identifier is determined. And the real time profiler 20 memorizes that all the demographic criteria of the specific profile are matched for the device identified by its unique device identifier.

Subscribers' demographic data 65 are transmitted to the real time profiler 20, by a demographic information system 60; and further memorized in the real time profiler 20. The demographic information system 60 may consist of a database of subscribers, containing information related to all the subscribers who have subscribed to the communication service. The information includes demographic data for each subscriber, and a unique subscriber identifier to uniquely identify each subscriber. The information may also contain data related to the device owned by each subscriber, including a unique device identifier for each device. Thus, the subscribers' demographic data 65 transmitted to the real time profiler 20, include for each subscriber: a unique subscriber identifier, and the demographic data of the subscriber. Additionally, a unique identifier of the device owned by the subscriber may be transmitted along the subscribers' demographic data, when available.

The subscribers' demographic data are static. They are updated to take into consideration new subscribers who subscribed to the communication service, subscribers who have resigned their subscription, or existing subscribers for whom demographic data have been obtained (or updated). Thus, the real time profiler 20 may be updated with subscribers' demographic data 65 on a regular basis; for instance every day, every week, or every month. When the real time profiler 20 is updated with subscribers' demographic data 65, the updated subscribers' demographic data 65 are memorized by the real time profiler 20. Additionally, the real time profiler 20 (immediately) analyzes the updated subscribers' demographic data with respect to the memorized profiles, to determine at least one device for which the demographic criteria of a specific memorized profile are met.

Similarly, when the real time profiler 20 is updated with a new profile 55, the new profile 55 is memorized by the real time profiler 20. And the real time profiler 20 (immediately) analyzes the memorized subscribers' demographic data with respect to the new profile, to determine at least one device for which the demographic criteria of the new profile are met.

The real time profiler 20 receives, from at least one collecting entity 150, IP data records 155 representative of an IP data traffic on an IP data network 100. The IP data traffic is generated by devices 110, 120 accessing Internet content and services 130 via the IP data network 110. The devices 110, 120 are owned by subscribers, who have subscribed to the communication service. Examples of such devices 110, 120 include mobile phones, computers, tablets, etc. A collecting entity 150 captures at least a portion of the IP data traffic on the IP data network 100, and extracts data from the captured traffic. The extracted data is transferred to the real time profiler 20 in the IP data records 155. Such collecting entities 150 are well known in the art, and may rely on Deep Packet Inspection technologies to extract the data, and generate the IP data records 155. For instance, the IP data records may contain a record for each device (110, 120), identified by a unique device identifier (extracted from the captured data). Each record may contain specific information, related to the Internet content and services 130 consumed by the specific device (110 or 120) corresponding to the record. Each record may also contain information related to the device itself (e.g. model, localisation, etc). The information is generated, by analyzing the captured data by means of Deep Packet Inspection.

In the context of the present method and system, an Internet content 130 consists in various media supports, including texts, images, audios, videos, etc; and combinations thereof. An Internet content 130 is delivered to a device (110 and 120), over the IP data network 100. An Internet service 130 consists in any type of application or service using the Internet Protocol for data transmission over the IP data network 100. Examples of such Internet services include: web browsing services, emailing services, instant messaging services, audio or video streaming services, social media services, Internet Protocol television (IPTV) services, on-line gaming services, etc.

Upon reception of an IP data record 155, the real time profiler 20 extracts in real time information from the received IP data record. The extracted information corresponds to the IP data traffic generated by a specific device (110, 120). And the real time profiler 20 analyzes in real time the extracted information, to determine that at least one of a contextual criterion or a data usage criterion of a specific profile is met. The analysis is performed for each device for which information is present in the received IP data record 155. For a specific device identified by its unique device identifier, the real time profiler 20 memorizes the contextual criteria and the data usage criteria of a specific profile (identified by its unique profile identifier), which have been determined as met.

Additionally, for a particular criterion, a temporary state of the criterion may be memorized. If the criterion is determined to be partially met (for a specific device) upon analysis of the information of an IP data record, a temporary state is memorized (for the specific device). Upon reception of additional IP data records, the particular criterion is further analyzed, in view of the temporary state and in view of the information from the additional IP data records. At some point, all the conditions for the particular criterion are met. Thus, the real time profiler 20 memorizes the particular criterion (of a specific profile) for a specific device, which has been determined as met.

Examples of such particular criteria include a pre-defined number of accesses to a particular web site or section of a web site, over a pre-defined period of time. Upon the first access (determined by analyzing the information in an IP data record), a temporary state is created. The temporary state contains the time at which the first access occurred. Upon reception of further IP data records, additional accesses may occur. Upon each access, the temporary state is updated with the current number of accesses. If the pre-defined number of accesses occurs within the pre-defined period (based on the memorized time of the first access), the particular criterion is determined to be met.

The real time profiler 10 monitors in real time, for each device, and for each specific profile, the criteria of the specific profile which have been determined has met. When all the criteria of a specific profile are met for a device, the subscriber's state manager 30 is updated 25 in real time by the real time profiler 20. The subscribers' state manager 30 keeps a real time view of the devices meeting all the criteria of a specific profile, for all the profiles memorized in the real time profiler 20.

The subscribers' state manager 30 memorizes the unique identifier of a device, and a corresponding state of a specific profile. The corresponding state of the specific profile is indicative that all the criteria of the specific profile are met for the device. Additionally, the unique identifier of the specific profile may be memorized, in addition to the unique identifier of the device and the corresponding state (to handle the case where the subscribers' profiling system processes several profiles in parallel).

The information memorized by the subscriber's state manager 30 may be used by an external entity, like the profiling campaign manager 70. For this purpose, a unique identifier of a device is transmitted from the subscriber's state manager 30, to the profiling campaign manager 70. The transmission occurs if a corresponding state of a selected profile is indicative that all the criteria of the selected profile are met for a device. Then, the profiling campaign manager 70 determines a specific content to be delivered to the device identified by its unique identifier. The specific content is determined in relation to the selected profile.

In one embodiment, the profiling campaign manager 70 sends a request to the subscriber's state manager 30, for a selected profile identifier identified by its unique profile identifier. The subscriber's state manager 30 sends a response to the profiling campaign manager 70. The response contains the unique identifiers of all the devices, for which the corresponding state of the selected profile is indicative that all the criteria of the selected profile are met.

In another embodiment, the profiling campaign manager 70 sends a request to the subscriber's state manager 30, for a selected device identified by its unique device identifier. The subscriber's state manager 30 sends a response to the profiling campaign manager 70. The response contains the unique profile identifiers of all the profiles, for which the corresponding state of the profile is indicative that all the criteria of the profile are met for the selected device.

In still another embodiment, the subscriber's state manager 30 automatically sends information to the profiling campaign manager 70, when a pre-defined condition is met. For instance, the information consists in the unique identifiers of all the devices, for which the corresponding state of a pre-defined profile is indicative that all the criteria of the pre-defined profile are met. Alternatively, the information consists in the unique profile identifiers of all the profiles, for which the corresponding state of the profile is indicative that all the criteria of the profile are met for a pre-defined device. The pre-defined condition (e.g. a pre-defined profile identified by its unique profile identifier, a pre-defined device identified by its unique device identifier) may be defined by the profiling campaign manager 70, and transmitted to the subscriber's state manager 30.

The real time profiler 20 and the subscribers' state manager 20 are respectively composed of dedicated software programs, executed on dedicated computers. Alternatively, dedicated software programs corresponding to the real time profiler 20 and the subscribers' state manager 20, may be executed on the same computer.

In a preferred embodiment, dedicated hardware and/or software resources are allocated to the real time profiler 20 and the subscriber's state manager 30. This allows for the functionalities of the real time profiler 20 to be performed independently of the functionalities of the subscriber's state manager 30. Thus, each of the two entities has no impact on the performances of the other entity. Further, the subscriber's state manager 30 has no access to information related to the subscribers and to information related to the usage of the devices owned by the subscribers. This information is collected and processed at the real time profiler 20 level. Thus, confidentiality about the information related to the subscribers and the information related to the usage of the devices owned by the subscribers is guaranteed at the subscriber's state manager 30.

The collecting entities 150, the profile definition entity 50, the demographic information system 60, and the profiling campaign manager 70, are also respectively composed of dedicated software programs, executed on dedicated computers.

A refreshing period may be associated to a specific profile. A device for which all the criteria of the specific profile are met, is no longer considered to be meeting all the criteria when the refreshing period expires. The refreshing period of the profiles may be managed by the subscriber's state manager 30. A timestamp is associated to the corresponding state of a specific profile with a refreshing period (for a given device). The timestamp is generated and memorized, when the corresponding state is determined to be matching all the criteria of the specific profile. When the refreshing period expires with respect to the memorized timestamp, the corresponding state is modified to indicate that all the criteria of the specific profile are no longer met. The subscriber's state manager 30 may further indicate to the real time profiler 20, that the status of the device associated to the corresponding state shall be refreshed. For this device, the criteria of the specific profile with the refreshing period are no longer met. The criteria may be met again in the future, based on the information received, memorized, and processed by the real time profiler 20. Only a fraction of the criteria may be set as not met by the real time profiler 20. For instance, only the (some) data usage criteria (and optionally the (some) contextual criteria) may be set to not met.

The specific content delivered to a device, by the profiling campaign manager 70, may be an advertising content. A specific profile corresponding to the advertising content is defined. For example, an advertising content promoting a car manufacturer, or a specific model of car from a car manufacturer, corresponds to a specific profile with specific criteria (the device visits web sites in relation to car manufacturers and models of cars, the device uses search engines with keywords related to car manufacturers and models of cars; the subscriber is in a specific range of age, and a specific range of revenue). The advertising content is delivered (by the profiling campaign manager 70) to a device identified by the subscriber's profiling system 10, as matching all the criteria of the specific profile corresponding to the advertising content.

Alternatively, the specific content delivered to a device, by the profiling campaign manager 70, may be a specific web content. A web portal may address different themes (e.g. sports, finance, fashion, media, finance, politics, etc). The content proposed on one or several dynamic web pages of the web portal is adapted to a specific device, using the present method and system. A specific profile is defined for each theme, with specific criteria related to each theme. The specific web content is delivered (by the profiling campaign manager 70) to a device identified by the subscriber's profiling system 10, as matching all the criteria of the specific profile corresponding to the theme of the specific web content.

In another alternative, the specific content delivered to a device, by the profiling campaign manager 70, may be a specific Internet Protocol Television (IPTV) and/or Video On Demand (VOD) content. The mechanism is the same as for a specific web content. IPTV and/or VOD contents are associated to specific profiles corresponding to specific themes (e.g. sports, news, drama, action, etc). Criteria representative of the interest for a specific theme are defined for each profile corresponding to a theme.

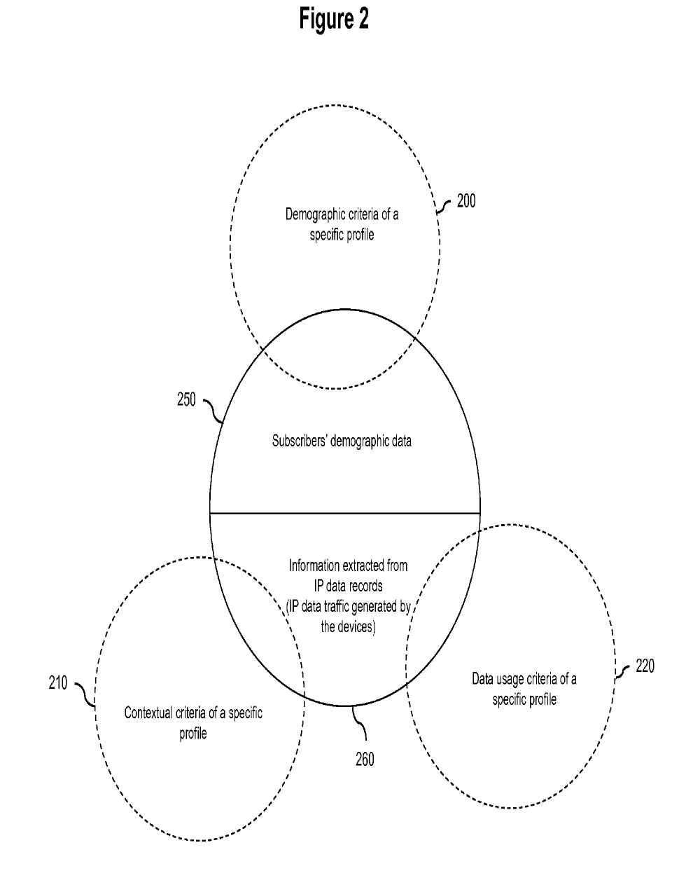

Now referring to FIG. 2, several types of criteria of a profile will be illustrated.

FIG. 2 represents three types of criteria that may be present in a specific profile. First, demographic criteria 200 related to demographic data representative of a subscriber. As already mentioned, they include: the age, the address, the profession, the revenue, of a subscriber.

Then, contextual criteria 210 related to characteristics and behaviors of a device itself. As already mentioned, they include: the manufacturer, the model, a characteristic, the localisation, of a device.

And, data usage criteria 220 related to characteristics and behaviors of the consumption of IP based data services by a device. As already mentioned, they include: an application used on the device, an Internet service consumed by the device, a content delivered to the device

The subscribers' profiling system 10 illustrated in FIG. 1 processes two types of data. First, demographic data 250 which correspond to a specific subscriber. Then, information extracted from IP data records 260, which correspond to the IP data traffic generated by a specific device owned by a subscriber.

The subscribers' demographic data 250 are analyzed with respect to the demographic criteria 200 of a specific profile. And the information extracted form the IP data records 260 are analyzed with respect to the contextual criteria 210 and the data usage criteria 220 of a specific profile.

Following are examples of demographic criteria 200, which may be defined in a specific profile. The gender of the subscriber is male. The address of the subscriber is a city among Montreal, Toronto, and Ottawa. The profession of the subscriber is teacher, engineer, and not layer. The revenue is in the range 60 0000 to 90 000 $.

Following are examples of contextual criteria 210, which may be defined in a specific profile. The manufacturer of the device is Nokia. The model of the device is iPhone 4. The model of the device is (any type of) smart phone. The model of the device is (any type of) feature phone. The model of the device is (any type of) tablet. The model of the device is any phone from RIM except models X and Y. The characteristic of the device is an LTE (Long Term Evolution) enabled mobile phone. The characteristic of the device is being powered by an Android operating system. The localization of the device (in the case of a mobile device) is a list of cells (identified by their cell ID). Alternatively, the localization of the device may be selected from a pre-defined list of areas (e.g. different pre-defined areas in a city). A mapping between a specific area and corresponding cells (defined by their cell ID) is memorized in the subscribers' profiling system 10 illustrated in FIG. 1.

Following are examples of data usage criteria 220, which may be defined in a specific profile. A specific VoIP application is used (by a device) N times over a period of time T (e.g. a day). The average amount of data corresponding to streaming traffic (generated by a device) is more than a given quantity per day. The type of content consumed (by a device) from an IPTV service is more than five action movies or sport shows over a period of time (e.g. one week). At least one among a list of Uniformed Resource Locators (URL) is accessed. A specific URL is accessed N times over a period of time T. At least one among a list of keywords is used in a search engine over a period of time T.

Referring back to FIG. 1, the present method and system is applicable to any type of mobile IP network (as an illustration of the IP data network 100 represented in FIG. 1), including without limitation: General Packet Radio Service (GPRS), Universal Mobile Telecommunication System (UMTS) network, Long Term Evolution (LTE) network, Code Division Multiple Access (CDMA) network, or Worldwide Interoperability for Microwave Access (WIMAX) network.

The present method and system is also applicable to any type of fixed broadband IP network (as an illustration of the IP data network 100), including without limitation: Digital Subscriber Line (DSL) networks, cable networks, or optical fiber networks

The present method and system is also applicable to an IP data network 100 operated by a corporation, for example a private company or a governmental/public organization.

Various types of devices (110 and 120) may be used to access the IP data network 100. Such devices include computers (110) in their broad sense (desktops, laptops, netbooks, etc). Such devices also include mobile devices (120) in their broad sense (feature phones, smart phones, tablets, etc). Such devices may also include televisions, video game consoles, etc. Based on the underlying access technology (mobile, fixed broadband, etc) of a specific IP data network 100, only a subset of the previously mentioned types of devices may be used. However, due to the convergence of the IP data networks 100 (specifically fixed and mobile convergence), more and more types of devices may be used to seamlessly access various types of IP data networks 100.

In an exemplary embodiment where the IP data network 100 is an UMTS cellular network, the collecting entities 150 may be positioned between a Serving GPRS Support Node (SGSN) and a Gateway GPRS Support Node (GGSN), in order to collect the IP traffic between these two equipments. This IP traffic is well known in the art as the GPRS Tunneling Protocol (GTP) control and user planes. A unique identifier of the device (110, 120) is extracted from the IP packets of the GTP control plane: the International Mobile Equipment Identity (IMEI). A unique identifier of the subscriber who owns the device (110, 120) is extracted from the IP packets of the GTP control plane: the International Mobile Subscriber Identity (IMSI), or the Mobile Station ISDN number (MSISDN). Using this information, the real time profiler 20 is capable of performing a mapping between a device identified by its IMEI; and a subscriber who owns the device, identified by its IMSI or MSISDN. Further, the subscribers' demographic data 65 memorized by the real time profiler 20 contain a unique identifier of the subscriber (the IMSI or the MSISDN), for each set of demographic data corresponding to a specific subscriber.

Although the present method and system have been described in the foregoing description by way of illustrative embodiments thereof, these embodiments can be modified at will, within the scope of the appended claims without departing from the spirit and nature of the appended claims.

1. A subscribers' profiling system for real time subscriber profiling, the system comprising:
a computer implemented real time profiler for:
memorizing at least one profile consisting of at least one criterion; wherein the at least one criterion consists of one of: a demographic criterion, a contextual criterion, and a data usage criterion;
memorizing subscribers' demographic data;
analyzing the subscribers' demographic data to determine at least one device for which the demographic criteria of a specific profile are met; wherein the at least one device is owned by a subscriber and the demographic criteria of the specific profile are met by the demographic data of the subscriber;
receiving from at least one collecting entity IP data records representative of an IP data traffic on an IP data network;
extracting in real time information from the IP data records, the information corresponding to the IP data traffic generated by a device;
analyzing in real time the extracted information to determine that at least one of a contextual criterion or a data usage criterion of a specific profile is met; and
updating in real time a computer implemented subscriber's state manager when all the criteria of a specific profile are met for a device; and
a computer implemented subscribers' state manager for:
memorizing a unique identifier of a device and a corresponding state of a specific profile; wherein the corresponding state of the specific profile is indicative that all the criteria of the specific profile are met for the device.

2. The subscribers' profiling system of claim 1, wherein a profile is identified by a unique profile identifier.

3. The subscribers' profiling system of claim 2, wherein memorizing at least one profile comprises memorizing the unique profile identifier of the at least one profile; and memorizing a unique identifier of a device and a corresponding state of a specific profile further comprises memorizing the unique profile identifier of the specific profile.

4. The subscribers' profiling system of claim 3, wherein a unique identifier of a device is transmitted from the computer implemented subscriber's state manager to a profiling campaign manager, if a corresponding state of a selected profile is indicative that all the criteria of the selected profile are met for the device.

5. The subscribers' profiling system of claim 4, wherein the profiling campaign manager determines a specific content to be delivered to the device identified by its unique identifier; the specific content being determined in relation to the selected profile.

6. The subscribers' profiling system of claim 1, wherein the at least one profile is transmitted to the computer implemented real time profiler entity by a profile definition entity.

7. The subscribers' profiling system of claim 1, wherein the subscribers' demographic data are transmitted to the computer implemented real time profiler entity by a demographic information system.

8. The subscribers' profiling system of claim 1, wherein the demographic criteria comprise a gender of a subscriber, an age of a subscriber, an address of a subscriber, a profession of a subscriber, a revenue of a subscriber.

9. The subscribers' profiling system of claim 1, wherein the contextual criteria comprise a manufacturer of a device, a model of a device, a characteristic of a device, a localisation of a device.

10. The subscribers' profiling system of claim 1, wherein the data usage criteria comprise an application used by a device, an Internet service used by a device, a content delivered to a device.
